(19) United States
(12) Patent Application Publication
(10) Pub. No.: US 2004/0216309 A1
(43) Pub. Date: Nov. 4, 2004

(54) Multi-function heavy duty utility knife with stabilizer pivot structure

(76) Inventor: Kristopher J. Mueller, Asheville, NC (US)

Correspondence Address: Kristopher J. Mueller, P.O. Box 674, Asheville, NC, 28802, US

(21) Appl. No.: 10/700,912

(22) Filed: Nov. 1, 2003

Related U.S. Application Data
(60) Provisional application No. 60/466,303, filed on Apr. 29, 2003.

(51) Int. Cl. B26B 29/00

(52) U.S. Cl. 30/286; 30/329

(57) ABSTRACT

The present invention relates to a Heavy Duty Utility knife with ergonomic finger and thumb positions in relation to an internal stabilizer pivot structure which includes a wheel for safer, stronger, smoother for more efficient cutting. The said invention also provides the user with an easy access, blade change and storage feature. This feature allows for proficiency of task, as well as, creating a safe knife with skid plate to prevent injury.

### RELATION TO PRIOR APPLICATION

This is a U.S. non-provisional application relating to and claiming the benefit of U.S. Provisional Application Serial No. 60/466,303 filed Apr. 29, 2003.

### BACKGROUND OF INVENTION

1. Field of Invention

This Invention relates to a hand held multiple use utility knife structure with specific ergonomic features for your fingers and thumb, in relation to the stabilize pivot structure. The knife contains a blade storage area and facilitates a quick open blade exchange, creating a unique tool for almost every field of construction, trades and home use. The design of the said structure provides the user with multiple ways to grip the tool, apply different amounts of pressure, and create leverage. The primary objective of the present invention is to provide leverage thus creating a safer working tool to minimize potentially harmful situations in dangerous heavy and light duty tasks.

2. Description of Prior Art

Prior inventions do have rollers or multiple wheels attached to utility knives. Almost all Construction Trades use utility knives depending on the scope of different applications in different industries. An example of Heavy Duty use is the roofing trade in which knives are the base tool for cutting and scoring shingles. Due to the heavyweight material used considerable pressure is exerted in order to cut the material. Thus, the Utility Knife plays an important role in the construction industry.

Innovation with design is needed to maintain safety and proficiency. The ineffective structure of traditional utility knives provides no support or stabilized pivot points with no way to create leverage thus creating a lack of precision cutting. In order to make a simple cut or score in a straight line traditional knives force the user to create leverage by straining the wrist or insure stability by straining the entire arm allowing for harmful situations.

Beyond the traditional utility knives there are several types of trade specific cutting tools. For example: fabric, sewing fabrics, screen splining, and even exacting knives with no heavy duty or multi-use design. Generally these are useful tools when applied to their specific industry or duty application but may be harmful when applied to other industries where proper cutting tools may be necessary.

In conclusion, I have found the need to create a knife with heavy duty, multi-use functions and design to assist in maintaining safety. The main goal asserted is in providing the roofing, sewing, flooring and any other construction industry (but not limited to these specifically) with a utility knife that maintains precision cutting in all heavy and light duty tasks.

### SUMMARY OF INVENTION

The primary objective of the present invention is to provide a stabilizer pivot structure, consisting of an internally mounted stabilizer pivot roller wheel with a rear skid plate to create a safer, more efficient utility knife to grip and handle in completing all construction tasks.

An additional objective of the present invention is to provide a Heavy Duty Multi use utility knife with ergonomic finger and thumb rests, pointer finger hub hole, stabilizer pivot structure with a spin opening, easy change blade and blade storage to create a safer, more efficient utility knife. By achieving these objectives a multi use tool of this kind will replace tools of inferior design.

This efficient, effective tool with multiple features maximizes safety, precision and versatility, concluding that this tool is unique and superior in its design. Other prior art displays that inferior design tools do not have heavy duty construction with precision elements needed in the prior art embodiment to complete necessary tasks.

In accordance with one form of this invention, there is provided a utility knife, including a housing, having a forward portion, a rear portion, and a middle portion. A cutting member is attached to the forward portion. The rear portion includes a grip for enabling a user to grasp the knife with a hand. A pivot wheel is attached to the middle portion. At least a part of the pivot wheel is received inside the housing so that the knife is stabilized during use. Preferably, the rear portion also includes a skid plate for protecting the user's hand.

### BRIEF DESCRIPTION OF THE DRAWINGS

FIG. 1 is a side view of present invention.

FIG. 2 is an exploded split internal view of present invention.

FIG. 3 is a side movement view illustrating opening feature of present invention.

FIG. 4-1 is a bottom view of present invention.

FIG. 4-2 is a side view of present invention.

FIG. 4-3 is an explode view of the opening mechanism.

FIG. 5 is a split internal view of specific features of present invention.

### DETAILED DESCRIPTION

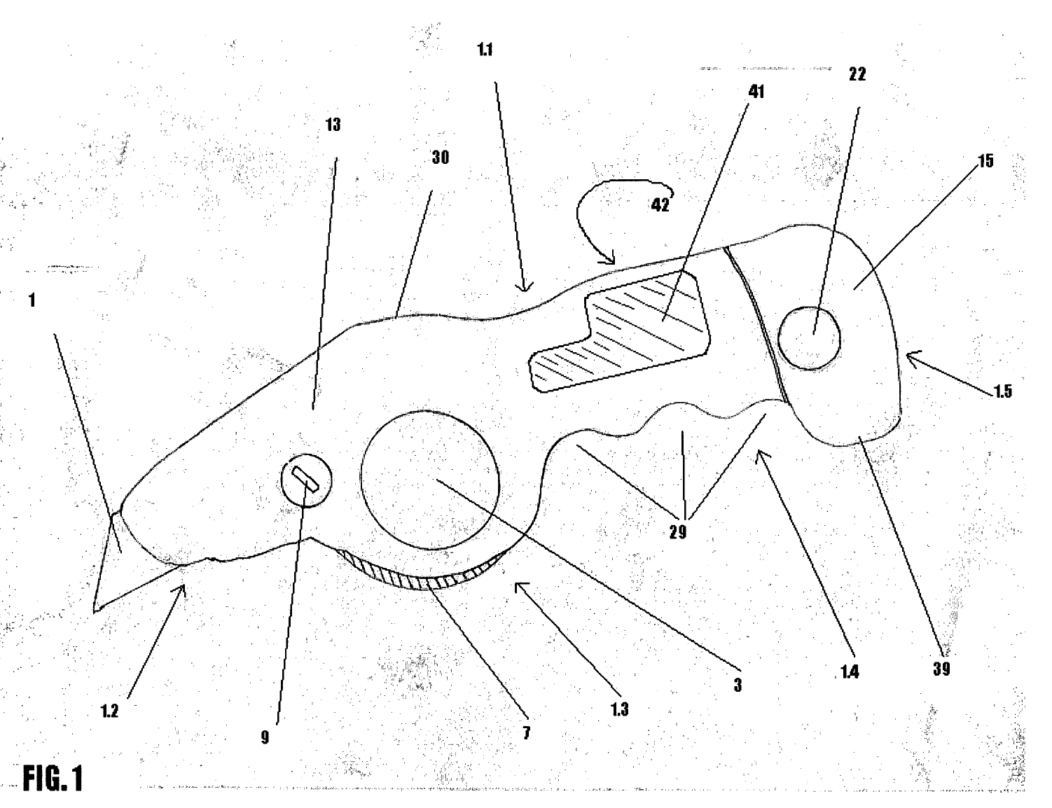

FIG. 1 shows one preferred embodiment of the present invention. A utility knife, in the form of housing 1.1, with blade 1 at forward portion 1.2, a stabilizer pivot wheel at middle portion 1.3 and on the bottom and a pointer finger hub hole 3 which you put your index finger through. Ergonomic finger rests or grip 29 at rear portion 1.4 and ergonomic finger rest 30 all create solid grip options for gripping. Knife housing first side 13 with female fastening nut for spin opener 9 along with knife housing second side 15 and spin opener engager for notch 22 creating a feature for quick blade change and storage called the spin opener. Protruding section 1.5 including skid plate 39 at rear of knife added with stabilizer pivot wheel 7 creating a safe way to keep your hand and knuckles from scraping the surface you're cutting. Including ergonomic side indentation 41 can help in additional multitask handling by putting thumb on one side and fingers on the other with ergonomic side indentation 42 to further make a complete knife.

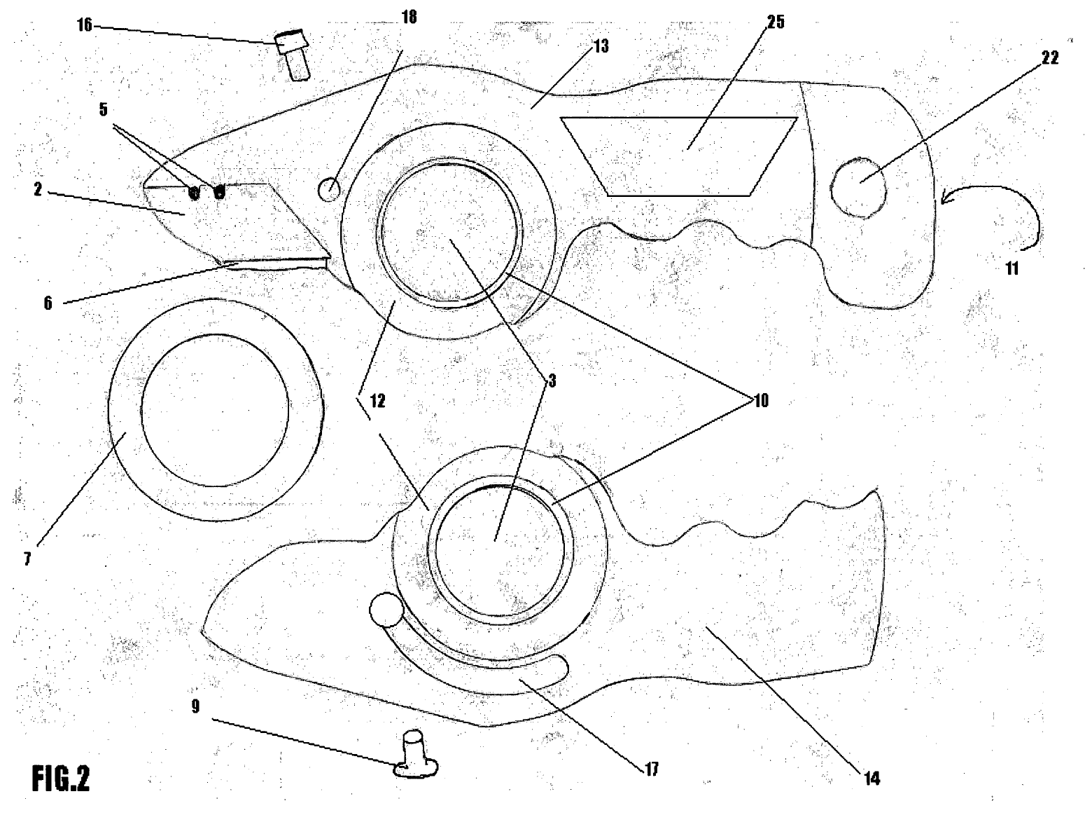

FIG. 2 shows further features of the present invention. Blade holder 2 and steel plate for blade holder 6 with steel pins for blade holder 5 create a solid and secure area for holding a blade. Knife Housing 13, Knife Housing 14 both sides have a pointer finger roller track 12 which the stabilizer pivot roller wheel 7, in the shape of a ring having rim 1.6, fits inside and the pointer finger hub wall 10 all create a stabilizer pivot structure. To open knife, engage spin opener button 11 opposite the side of the spin opener engager for notch 22 is located. Push knife housing 14 which slides along internal spin opener track 17 held together by female fastening nut or stud for spin opener 9 and male fastening screw for spin opener 16 through hole for nut and screw for spin opener track 18 which opens and exposes blade holder 2 creating an easy blade change and storage.

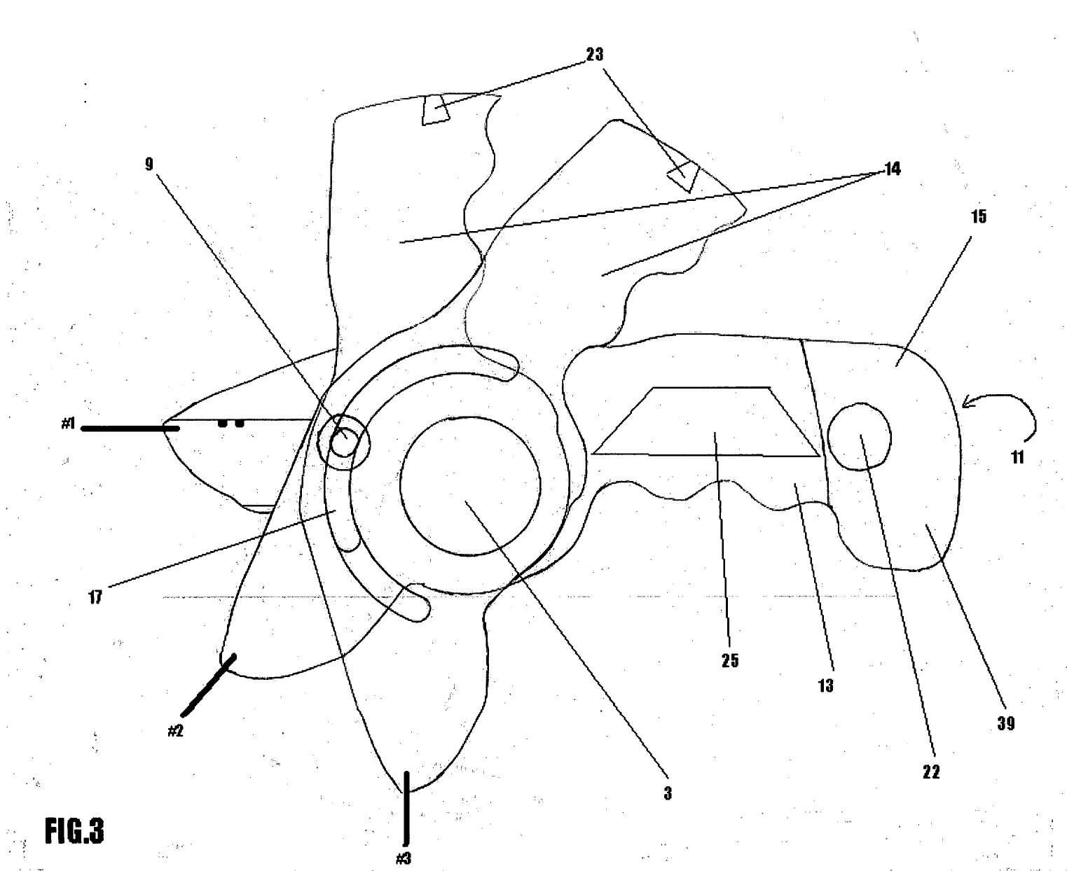

FIG. 3 to complete the explanation of FIG. 2 and FIG. 3 shows the slide movement in 3 parts. The pointer finger hub hole 3 stays in its original position when knife housing 14 spins along internal curved spin opener track 17 held together with both parts of the female fastening nut for spin opener 9 when the spin opener button 11 is pushed to release the spin opener engager for notch 22 is raised out of locking notch for spin opener catch 23 the knife can be opened to create an easy blade exchange and blade storage 29. This process leaves rear skid plate 39 attached to knife housing 13 comprising spin opener push button 11 which is found within knife housing 15 which is half of the rear skid plate 39. To close knife simply close knife housing 14 together with knife housing 13 back to position 1 and push spin opener button 11 to reset spin opener engaging for notch 22 in locking notch for spin opener catch 23.

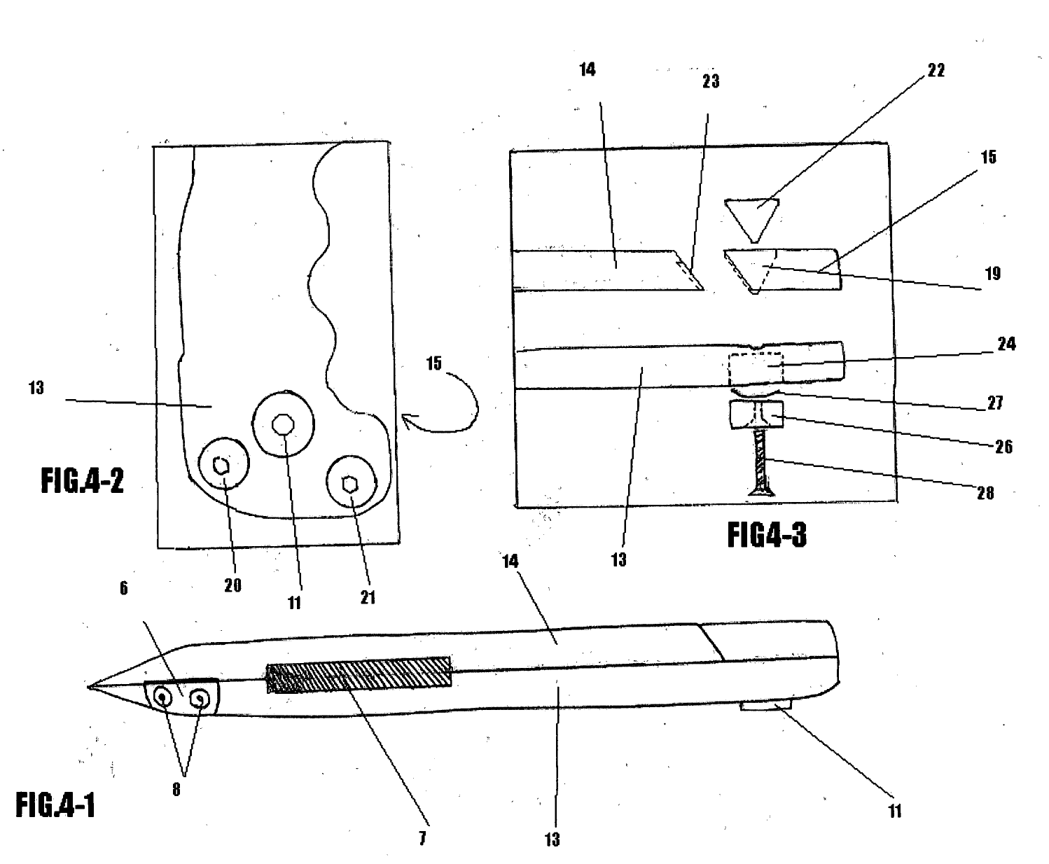

FIG. 4-1 shows the bottom of knife with stabilize pivot wheel inside knife housing 13 and knife housing 14 to create the stabilize pivot structure. Screws for steel plate for blade holder 8 attach steel plate for blade holder 6 to the underneath of knife housing 13 to create a solid area for blade. Spin opener button 11 opposite knife housing protrudes knife housing 13 to engage spin opening.

FIG. 4-2 shows how knife housing 15 is attached with upper fastening screw 20 and lower fastening screw 21 to knife housing 13 with spin opener button 11 shown.

FIG. 4-3 shows the entire spin opener button 11 shown in FIG. 4-2 and FIG. 4-1 is exploded to show how spin opener button 11 mechanism is held together and what it's composed of. Spin opener screw 28 slides into spin opener push button block 26 through round leaf spring 27 all slide into spin opener push button block depression 24 inside knife housing 13 connecting through to spin opener engager for notch depression 19 with spin opener engager for notch 22 to slide into knife housing 15 to create spin opener button 11. When spin opener screw 28 fastens to spin opener engager for notch 22 through all components and are combined, then spin opener button 11 comprising all components is pushed, round leaf spring 27 depresses, spin opener engager for notch 22 releases from locking notch for spin opener catch 23 on knife housing 14 to create easy opening, access to blade storage and easy blade exchange.

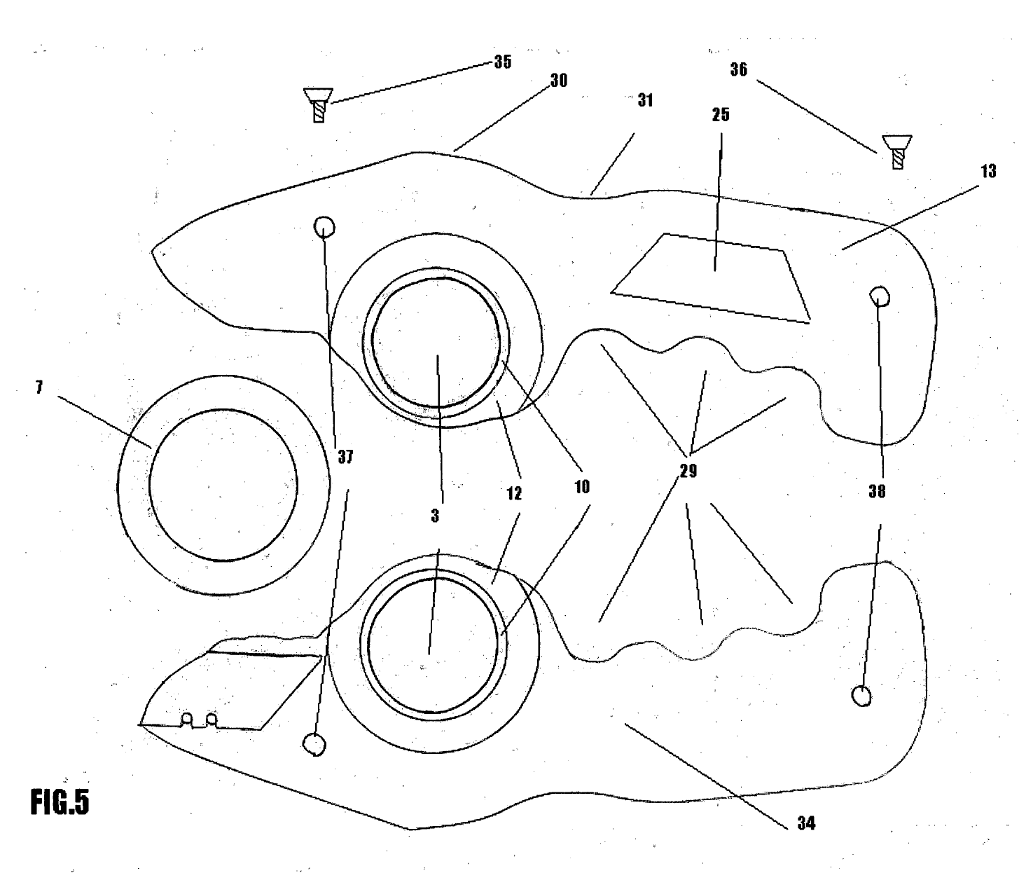

FIG. 5 shows an alternative embodiment of the present invention with simple two screw feature fastening with front fastening screw 35 rear fastening screw 36 through front fastening hole 37 and refastening hole 38 fastening to knife housing 34 encasing stabilizer pivot roller wheel 7 in pointer finger roller truck 12 with pointer finger hub wall 10 with knife housing 13 creating a utility knife with stabilizer pivot structure and pointer finger hub hole 3 which index finger goes through. Along with ergonomic finger rests 29 ergonomic thumb rest 30 ergonomic thumb position 31 creating a simple fastening heavy duty multi-use utility knife with stabilizer pivot structure.

The complete function of the present utility knife invention prevents strain while heavy cutting and scoring with multiple ergonomic features and unique point finger hub hole. Along with stabilizer pivot structure and rear skid plate create an incredibly safe design when cutting rough material. Unique spin opener, quick blade change and storage is a solid design for proficiency of task.

While this form of apparatus herein explained constitutes preferred embodiment of this invention it is to be understood that the present invention is not limited to this precise form of apparatus and that changes may be made other without departing from the scope of the invention which is defined in the apparatus claims.

1. A utility knife comprising:
a housing; said housing having a forward portion, a rear portion, and a middle portion;
a cutting member; said cutting member attached to said forward portion;
said rear portion, including a grip for enabling a user to grasp the knife with a hand;
a pivot wheel; said pivot wheel attached to said middle portion; at least a part of said pivot wheel received inside said housing whereby the knife is stabilized during use.

2. A utility knife as set forth in claim 1 wherein said housing includes first and second sides; each including a wheel track for receiving said pivot wheel.

3. A utility knife as set forth in claim 1 further including an opening extending through said middle portion; said opening adapted to receive the index finger of the user.

4. A utility knife as set forth in claim 3 wherein said wheel is in the shape of a ring having a rim; said rim adjacent to said opening.

5. A utility knife as set forth in claim 4 further including a curved hub wall inside said housing and extending about said opening; said rim of said wheel adjacent to said hub wall and engaging at least a portion of said hub wall during use of said knife.

6. A utility knife as set forth in claim 1 wherein said knife is adapted to cut a work piece; said rear portion including a protruding section which is not part of said grip; said protruding section adapted to protect the hand of the user which grasps the knife from contacting the work piece.

7. A utility knife as set forth in claim 6 wherein said protruding section includes a skid plate.

8. A utility knife as set forth in claim 1 further including a storage compartment in said housing; said storage compartment adapted to receive spare cutting members.

9. A utility knife as set forth in claim 1 wherein said housing has first and second sides and a mechanism for securing said first side to said second side; a storage compartment in said housing; said storage compartment adapted to receive spare cutting members; a rotation mechanism for enabling said first and second sides to rotate relative to one another to a second position so that said storage compartment is accessible to the user; said storage compartment being covered by said first and second sides when said first and second sides are in a first position relative to one another.

10. A utility knife as set forth in claim 9 wherein said rotation mechanism, including a stud attached to and projecting from said first side and a curved track in said second side; said stud received in said curved track; said stud enabled to move along said curved track.

11. A utility knife as set forth in claim 9 including a lock/release mechanism; said lock/release mechanism enabling said first and second sides to be locked into said first position and released to be placed in said second position.

12. A utility knife as set forth in claim 11 wherein said lock/release mechanism includes a push button release mechanism and a locking notch.

13. A utility knife comprising:
a housing; said housing having a forward portion, a rear portion and a middle portion;
a cutting member; said cutting member attached to said forward portion; said rear portion, including a grip for enabling a user to grasp the knife with a hand; and
said middle portion, further including an opening extending through said middle portion; said opening adapted to receive the index finger of the user.

14. A utility knife as set forth in claim 13 wherein said rear portion includes a skid plate.

15. A utility knife as set forth in claim 13 wherein said middle portion includes a stabilizer pivot structure.
